(19) United States
(12) Patent Application Publication
(10) Pub. No.: US 2022/0249306 A1
(43) Pub. Date: Aug. 11, 2022

(54) WHEEL CHAIR FOR CONTACTLESS BOARDING INTO A VEHICLE

(71) Applicant: Dizella CARMICHAEL, Stafford, TX (US)

(72) Inventor: Dizella CARMICHAEL, Stafford, TX (US)

(21) Appl. No.: 17/173,382

(22) Filed: Feb. 11, 2021

(51) Int. Cl. A61G 5/10; A61G 3/08; A61G 3/06

(52) U.S. Cl. CPC A61G 5/10; A61G 3/061; A61G 3/0808

(57) ABSTRACT

A wheelchair for onboarding a wheel chair person into a vehicle including a wheelchair and a king pin adapted to the wheelchair. The kingpin may be configured for positioning within an opening of a fifth wheel adapted to a vehicle configured for moving the wheelchair into a vehicle. Alternatively, a fifth wheel may be adapted to the wheelchair and a king pin to the vehicle. A system for onboarding a wheel chair person may include a wheelchair, a carriage, a fifth wheel, a king pin, a ramp latch mechanism, a fifth wheel latch mechanism, a processor, memory, and a switching mechanism. Instructions executable by the processor may: select ramp latch mechanism, determine ramp status, and active up/down the ramp; select fifth wheel latch mechanism, determine fifth wheel status, and on/off the fifth wheel. Other features include camera, dash panel control, no-contact panels, connection with external utility, and other features.

### TECHNICAL FIELD

The present disclosure is directed to wheelchairs for vehicles. More specifically, this disclosure is directed to a wheelchair for onboarding a wheel chair person into a vehicle.

### BACKGROUND

Wheelchairs for onboarding a wheel chair person into a vehicle are known. Generally, they involve some interaction between people and wheel chair person to onboard the wheel chair into the vehicle.

In the era of the Covid pandemic, there is urgency in maintaining social distancing to minimize the spread of the virus. Even without the pandemic, there is a need for more efficiency in onboarding a wheel chair person into a vehicle. This disclosure addresses that need.

Unless otherwise indicated herein, the materials described in this section are not prior art to the claims in this application and are not admitted to be prior art by inclusion in this section.

### SUMMARY

Disclosed is a wheelchair for onboarding a wheel chair person into a vehicle including a wheelchair and a king pin adapted to the wheelchair. The kingpin may be configured for positioning within an opening of a fifth wheel adapted to a vehicle configured for moving the wheelchair into a vehicle. Alternatively, a fifth wheel may be adapted to the wheelchair and a king pin to the vehicle. A system for onboarding a wheel chair person may include a wheelchair, a carriage, a fifth wheel, a king pin, a ramp latch mechanism, a fifth wheel latch mechanism, a processor, memory, and a switching mechanism. Instructions executable by the processor may: select ramp latch mechanism, determine ramp status, and active up/down the ramp; select fifth wheel latch mechanism, determine fifth wheel status, and on/off the fifth wheel. Other features include camera, dash panel control, no-contact panels, connection with external utility, and other features.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 shows prior art wheel chair.

FIG. 2 shows wheel chair according to an example embodiment of this disclosure.

FIGS. 3A, 3B, 3C (collectively FIG. 3) show an illustrative ramp according to this disclosure.

FIGS. 4A, 4B, 4C (collectively FIG. 4) show an illustrative chain drive embodiment of this disclosure.

FIGS. 5A, 5B, 5C (collectively FIG. 5) show an illustrative embodiment of positioning an illustrative chain drive embodiment of this disclosure.

FIG. 6 shows an illustrative embodiment of a motorized controller according to this disclosure.

FIGS. 7A, 7B (collectively FIG. 7) show an illustrative embodiment of subsystem fifth wheel according to this disclosure.

FIG. 8 shows an illustrative embodiment of an alternative wheel chair according to this disclosure.

FIG. 9 shows top plan view of an illustrative embodiment of a system according to this disclosure.

FIG. 10 shows perspective view of the illustrative embodiment of FIG. 9.

FIG. 11 shows an illustrative embodiment of a control system of this disclosure.

FIG. 12 shows an illustrative process of this disclosure.

FIG. 13 shows connection of the system with an external utility according to this disclosure.

FIG. 14 shows a method of this disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally speaking, disclosed is a wheelchair for onboarding a wheel chair person into a vehicle including a wheelchair and a king pin adapted to the wheelchair. The kingpin may be configured for positioning within an opening of a fifth wheel adapted to a vehicle configured for moving the wheelchair into a vehicle. Alternatively, a fifth wheel may be adapted to the wheelchair and a king pin to the vehicle. A system for onboarding a wheel chair person may include a wheelchair, a carriage, a fifth wheel, a king pin, a ramp latch mechanism, a fifth wheel latch mechanism, a processor, memory, and a switching mechanism. Instructions executable by the processor may: select ramp latch mechanism, determine ramp status, and active up/down the ramp; select fifth wheel latch mechanism, determine fifth wheel status, and on/off the fifth wheel. Other features include camera, dash panel control, no-contact panels, connection with external utility, and other features.

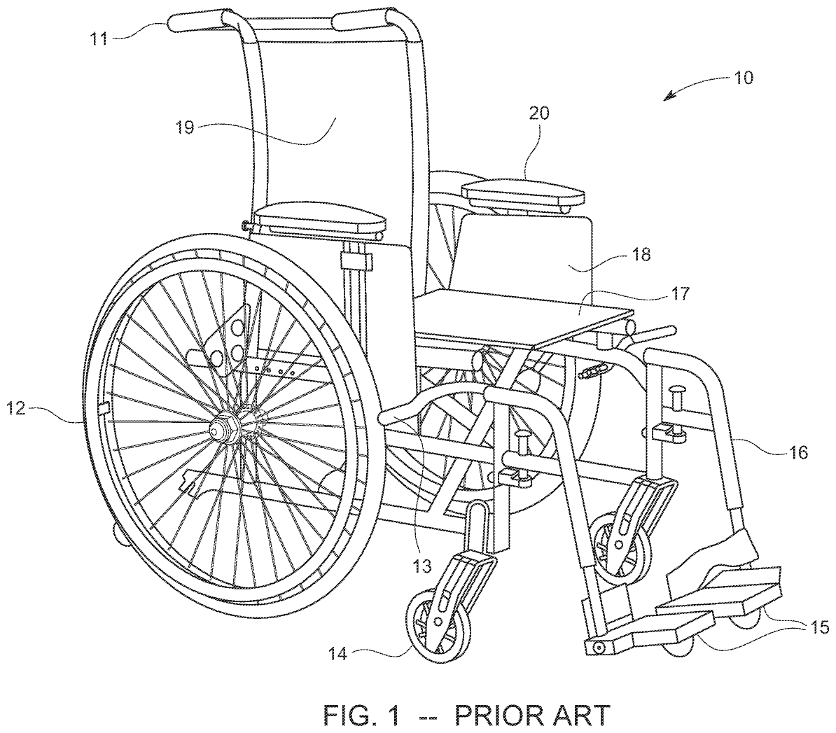

Turning to FIG. 1, FIG. 1 shows prior art wheel chair 10 comprising hand grip 11, rear wheel 12, brakes 13, caster front 14, footplate 15, rigging 16, seat upholstery 17, side upholstery 18, back upholstery 19, and armrest 20. These features and the functioning of those features are well known in the art.

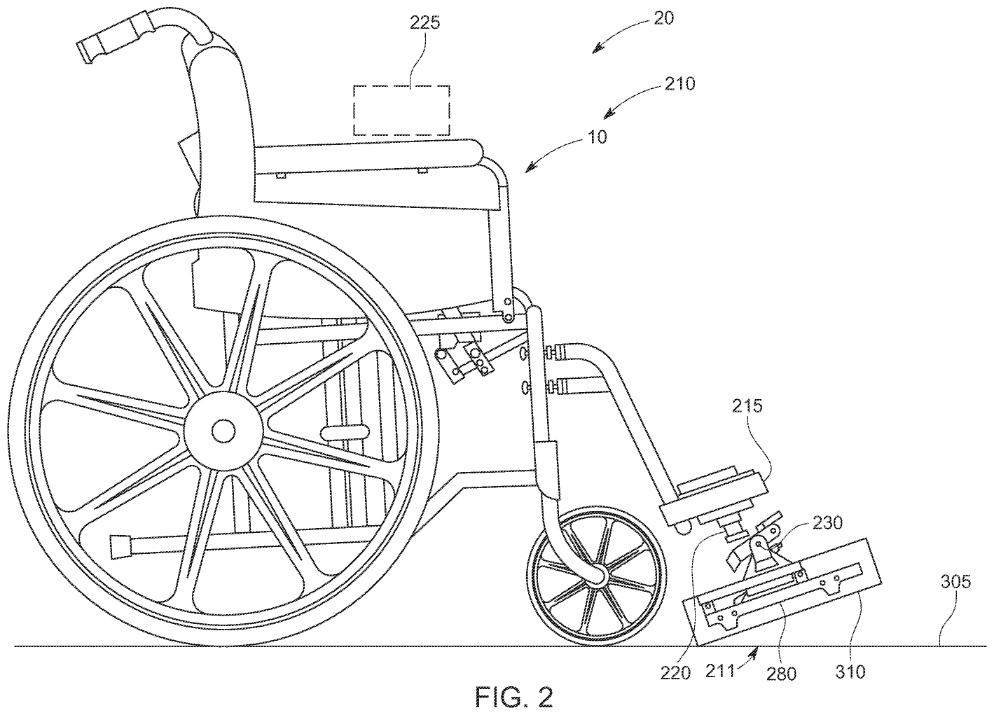

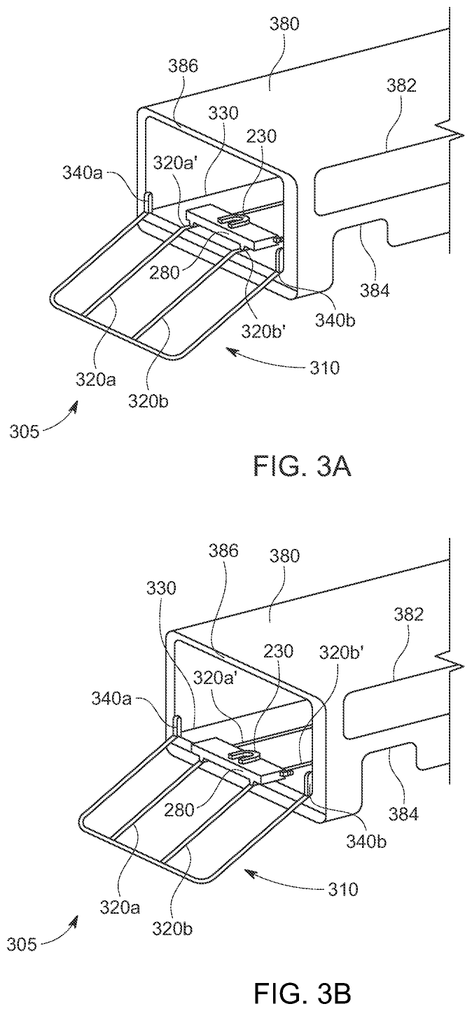

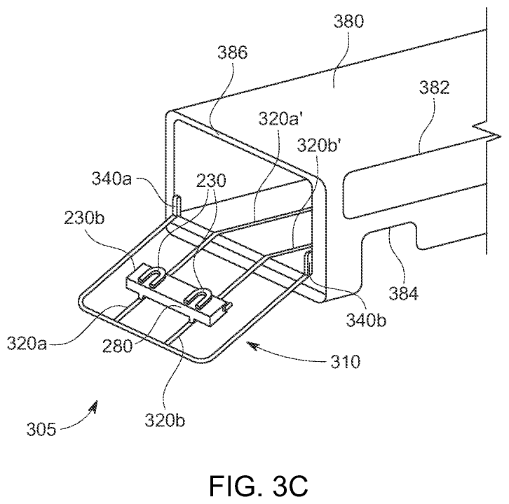

FIG. 2 shows wheel chair 210 according to an example embodiment of this disclosure. As depicted in FIG. 2, a prior art wheel chair 10 as shown in FIG. 1 is provided with king pin 220 on an underside of footplate 15 of wheel chair 10 for mating with a fifth wheel 230 attached to a movable carriage 280 that is configured to move along a ramp 310. The ramp and the travel of the moveable carriage along the ramp are more clearly depicted in FIG. 3 and explained below. Referring still to FIG. 2, as the wheelchair moves in the direction of arrow 211, the kingpin 220 contacts and connects and engages with fifth wheel 230.

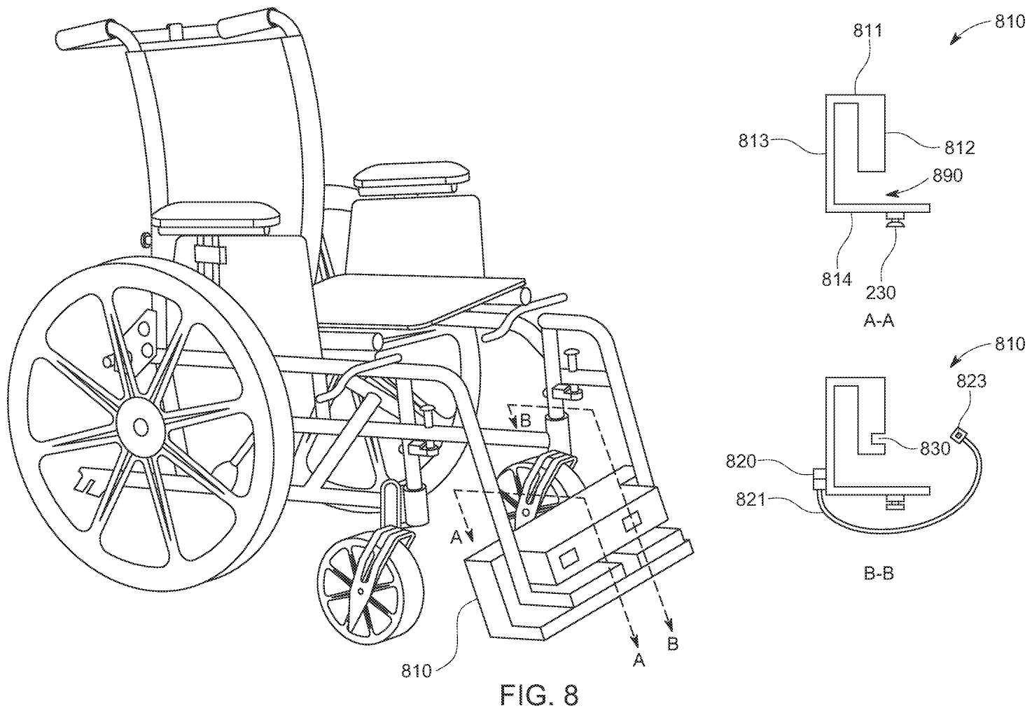

In the previous embodiment, the king pin 220 is illustratively depicted to be adapted to an underside of the wheelchair. The underside of the wheelchair may be the underside of a footrest 215 of the wheelchair 10. In an alternative embodiment depicted in FIG. 8, the kingpin may be a part of a wheelchair accessory item 810 and the adaption of the kingpin to the underside of the wheelchair to the underside of a footrest of the wheelchair may be by attachment of the wheelchair accessory item to the footrest of the wheelchair. As shown in the side view A-A of FIG. 8, the wheelchair accessory item 810 may include an opening 890 defined by bottom portion 814, back portion 813, top portion 811, and overhang portion 812. The king pin 230 is attached to the bottom of the bottom portion 814 in this illustrative example. As shown in the side view B-B of FIG. 8, an accessory belt 821 secured to the back portion 813 by an attachment mechanism 820 may include a buckle 823 for clicking engagement into a locking mechanism 830 operating for example like a seat belt buckle and attachment mechanism.

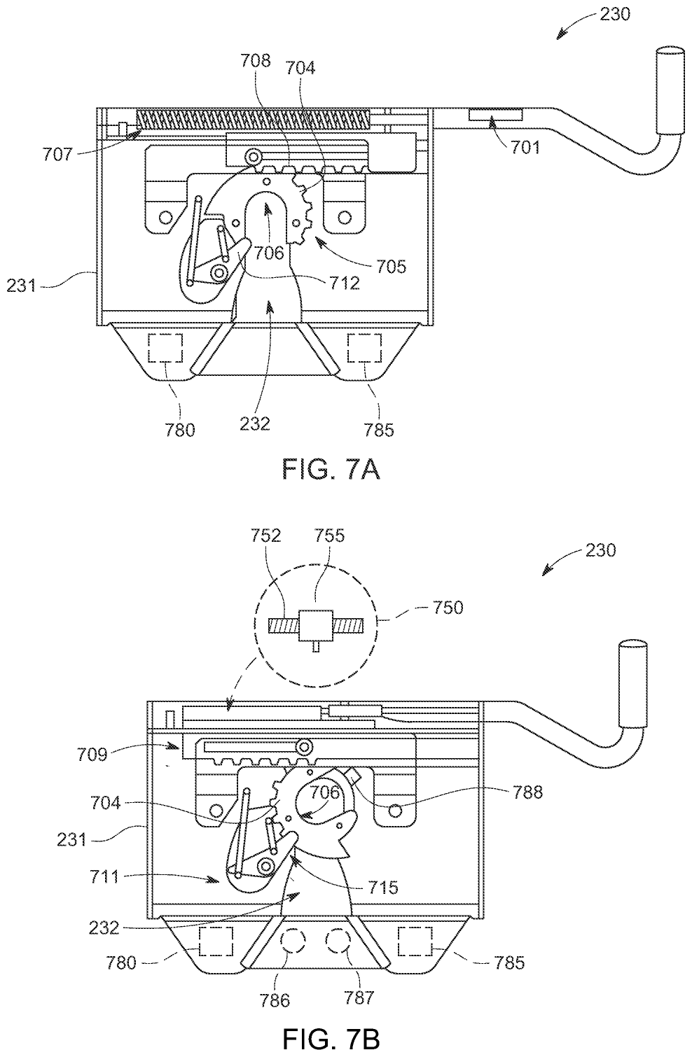

Turning now to the mechanism for engagement of the kingpin to the fifth wheel on contact, we refer to FIG. 7. FIG. 7 depicts the fifth wheel 230 which may include a housing 231, a lock jaw assembly 705, a lock catch 711, a lock bar 709, a lock bar spring 707, and a handle catch 701. The housing 231 may be formed in the shape of a horseshoe defining an opening 232, The lock jaw assembly 705 may define along an inner region an opening 706 in the shape of the opening 232 of the housing 231, in this case a horseshoe opening and along an outer region a set of teeth 704. The lock catch 711 may pivotally attach to the fifth wheel 230 the lock catch may define an extending member 712 configured to engage the set of teeth 704 of the lock jaw assembly 705. The lock bar 701 may extend along a top of the horseshoe opening of the housing and include a set of teeth 708 for mating with the set of teeth 704 of the lock jaw assembly. The lock bar may be configured for axial movement along the top of the horseshoe opening 232. The lock bar spring may be secured at one end to the housing and at another end to a handle catch 701. The handle catch may be configured for axial movement along the top of the lock bar spring. Extension of the handle catch away from the housing may move the lock bar in a direction away from the housing under the influence of the spring with the set of teeth of the lock bar rotably moving the lock jaw assembly and the extending member of the lock catch to an unlocked position. Relaxation of the handle may return the lock bar and the spring to a normal position with the set of teeth of the lock bar rotably moving the lock jaw assembly and the extending member of the lock catch back to a locked position.

While the fifth wheel in the above embodiment is illustratively depicted with a manually operated handle catch, in an alternative embodiment the handle catch may be automated by a motorized screw assembly 750. The motorized screw assembly 750 may include a screw 752 driven by an electric motor 755. The motor may be powered by a power source 780 which may be a battery pack. Alternatively the power may be provided by a power source on the vehicle which may be tethered to the electric motor 755 by hard wire.

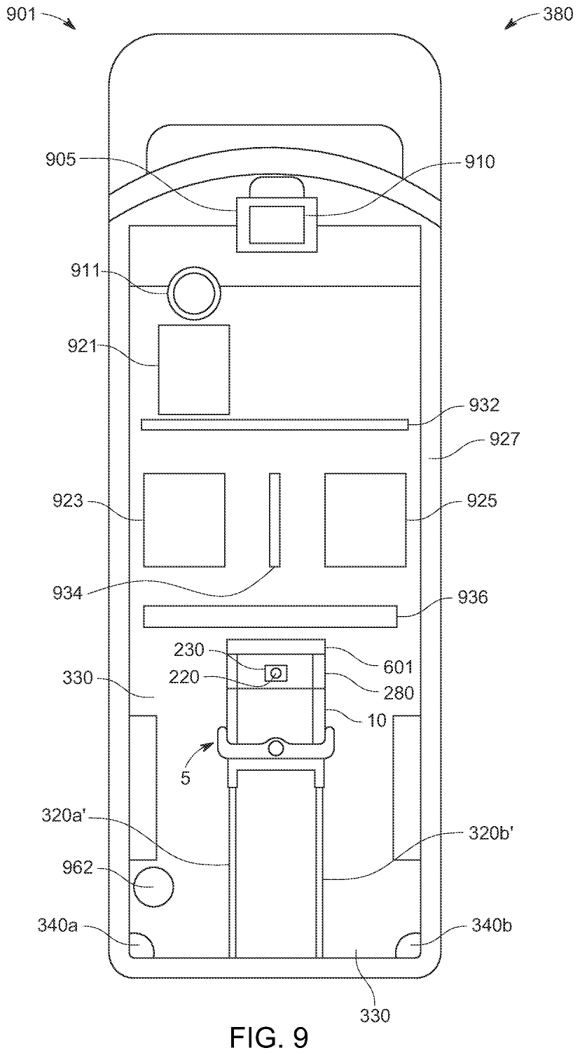

FIG. 7 also depicts an electronic chip set 785 that the fifth wheel may include. The electronic chip set may include a processor, memory, a wireless communication chipset, and instructions in the memory that determine when the king pin is inside the fifth wheel and move the lock catch to the locked position when the king pin is inside the fifth wheel and move the lock catch to the open position when the king pin is to be moved out of the fifth wheel. The movement of the lock catch to the locked position may occur under a sensor generated signal that indicates the king pin is in position to be locked to the fifth wheel. A sensor that may be used for this purpose is explained below. The movement of the lock catch to the unlock position may occur by a driver or other person associated with the vehicle activating a king pin inside fifth wheel latch from computing device 905 depicted in FIG. 9. It may also occur by activation of a king pin inside fifth wheel latch from a computing device 225 shown in FIG. 2 which may include a processor, memory, a wireless communication chipset, and instructions in the memory to communicate with the electronic chip set 785 and cause it to operate the king pin inside fifth wheel latch. The movement of the lock catch to the lock and unlock positions may also occur at the wheel chair by activatable unlock button 787 and lock button 786 provided on the fifth wheel which may allow a person at a wheel chair to manually activate the lock and unlock features of the fifth wheel disclosed herein.

As previously explained, the fifth wheel may include a sensor to detect when the king pin has been positioned within the opening of the horseshoe of the fifth wheel. FIG. 7 depicts this sensor in the fifth wheel as sensor 787. The detected positioning being a condition for operation of the motorized controller 601 depicted in FIG. 9 to which the carriage 280 carrying the fifth wheel may be attached. The sensor may generate an electrical signal when the king pin has been positioned within the opening of the horseshoe of the fifth wheel. The electrical circuitry may apply a signal to the communication circuitry on detection of the sensor generated electrical signal, The communication circuitry may be configured to transmit a signal to a receiver in a computing device 905 depicted in FIG. 9 in response to the signal applied by the electrical circuitry. The detected positioning may be a condition for operation of the motorized controller 601 depicted in FIG. 9 to which the carriage 280 carrying the fifth wheel may be attached.

Turning now to how a wheelchair with a king pin adapted to the wheelchair that is engaged by a fifth wheel as previously explained is onboarded into a vehicle, reference is made to FIGS. 3-6 and 9, 10.

As shown in FIG. 3, the movable carriage 280 (first depicted in FIG. 2) moves along a ramp 310 and a bed 330 of a vehicle 380. FIGS. 3A, 3B, 3C (collectively FIG. 3) show an illustrative ramp 310 extending from vehicle 380 to ground 305 which may be configured to provide a tailgate for the vehicle 380 as shown. Vehicle 380 is depicted in FIG. 3 with window 382 and wheel well 384 and vehicle bed 330. When the ramp or tailgate is opened away from tail window frame 386 of the vehicle 380 and pivoted to the ground 305, tail window frame 386 is opened up for the wheel chair with person to enter the vehicle. When the ramp 310 or tailgate is moved against the tail window frame 386, the opening of the tail window frame is closed to the outside elements. Seals provided along the edges of the ramp 310 and along the tail window frame may be used to provide a good seal between the ramp 310 or tailgate and the tail window frame 386 when the ramp 310 or tailgate is in the closed position. As depicted in FIG. 3, motorized controllers 340a. 340b connected to the turn end of the ramp 310 or tailgate may open and close the ramp or tailgate when energized in accordance with this disclosure.

While the ramp 310 extending from the vehicle 380 to the ground may be configured to provide a tailgate for the vehicle; it will be appreciated that the ramp extending from the vehicle to the ground may also be configured to provide a hatch for the vehicle. For example, motorized controllers like motorized controllers 340a, 340b may be added to the vehicle along the top of the tail window frame such as to mirror motorized controllers 340a, 340b that run along the bottom of the tail window frame and be connected to the end of the ramp 310 that is configured to contact the ground in order to allow the ramp to be opened as a hatch when energized if a hatch feature of this disclosure is needed. The number and location of motorized controllers to effectuate tailgate or hatch functionality is a matter of design choice.

In another embodiment, the ramp 310 extending from the vehicle to the ground may be configured to lie on or under the bed of the vehicle. In these embodiments, the ramp may be controlled by a motorized controller. For example, the extension of the ramp away from the vehicle and to the ground in one direction and from the ground to the vehicle to lie on or under the bed of the vehicle in the other direction may be automated by a motorized screw assembly similar to the one previously described in connection with motorized screw assembly 750. The motorized screw assembly may include a screw driven by an electric motor. The axis of the screw may be oriented in the direction of the tail window frame 386 of the vehicle 380. The end of the screw may be attached to the vehicle end of the ramp so the screw pushes the ramp outwardly and inwardly on activation by the motorized controller. Motorized controllers like motorized controllers 340a, 340b connected to the turn end of the ramp 310 or tailgate may be provided to coact with the motorized screw assembly to allow for tilting of the ramp 310 toward and to the ground and away from and toward the vehicle. For example, the motorized screw assembly may extend the ramp 310 or tailgate to clear the vehicle whereupon the motorized controllers may cause the ramp 310 or tailgate to tilt to the ground as previously explained. All of these controls may be provided by control system 1101 described later in this disclosure.

In addition, while tailgate or hatch functionality has been described in connection with motorized controllers, it will be appreciated that these functionalities may be effectuated manually without motorized controllers. Manual and motorized control of tailgate or hatch functionalities are part of this disclosure.

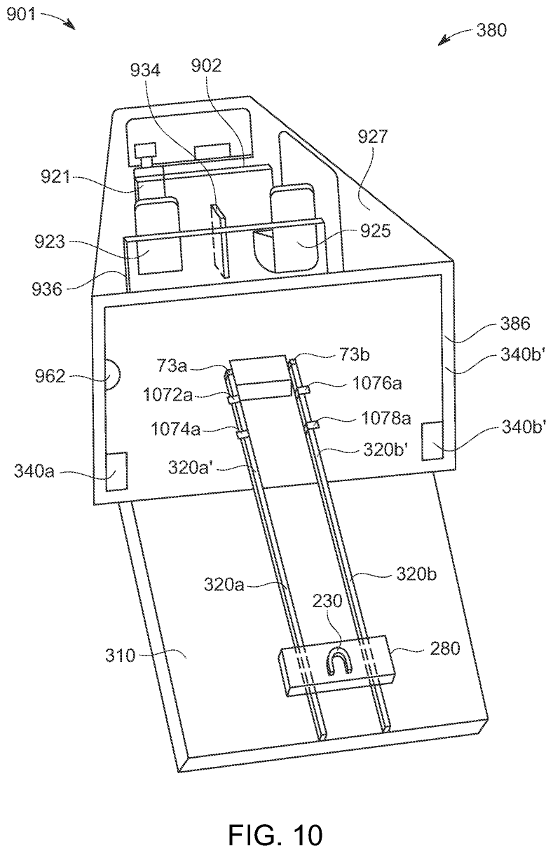

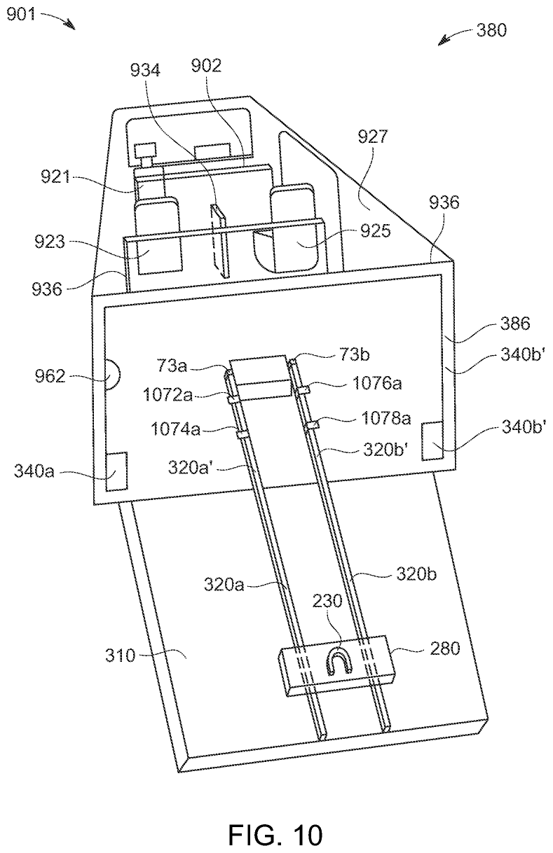

Advantageously, and referring still to FIG. 3, ramp 310 is provided with tracks 320a, 320b which run from the ground 305 up to vehicle bed 330 and continue along the vehicle bed 330 as tracks 320a′, 320b to an end terminating inside the vehicle bed 330 which is not shown in FIG. 3 but is shown in FIG. 10 as stops 73a, 73b. The tracks allow carriage 280 to move under the influence of a motorized controller 601 depicted in FIGS. 9 and 10 horizontally along the rectilinear path defined by the ramps along the bed of the vehicle and the ramp extending therefrom to the ground.

As previous explained in connection with FIG. 2, carriage 280 carries fifth wheel 230. While FIGS. 3A, 3B show carriage 280 carrying a single fifth wheel, FIG. 3C shows carriage 280 carrying two fifth wheels to illustrate an alternative embodiment employing two or more fifth wheels as part of this disclosure. Each fifth wheel that may be used with this disclosure may be configured for operation with a counterpart king pin as taught in this disclosure. Also to note is that the fifth wheel depicted in FIG. 3 is a simplified rendering of the depiction of the fifth wheel as disclosed for example in FIGS. 2 and 7.

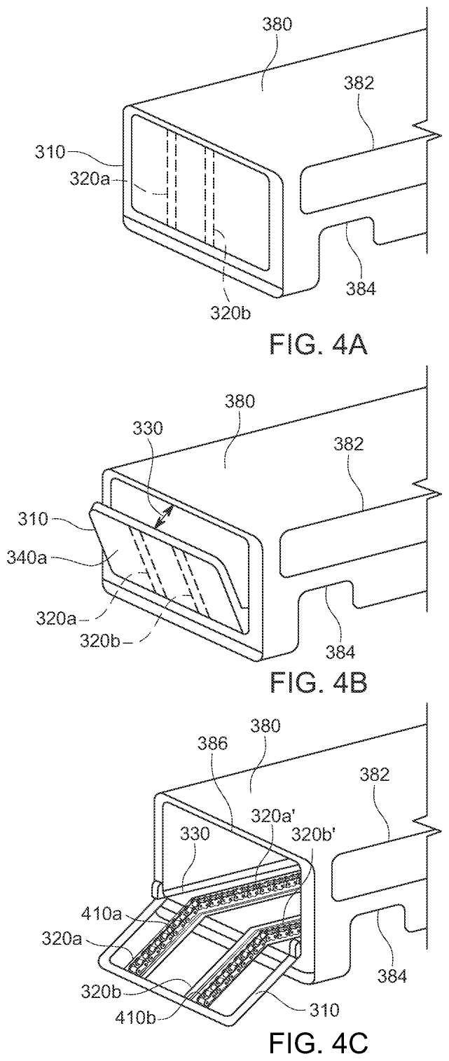

FIGS. 4A, 4B, 4C (collectively FIG. 4) show an illustrative chain drive embodiment of this disclosure. The chain drive 410a, 410b is depicted in FIG. 4C to lie within tracks 320a, 320b. As shown in FIG. 4C, tracks 320a, 320b are accessible by a wheel chair when the ramp 310 is open. Only phantom lines for tracks 320a, 320b are shown in FIGS. 4A, 4B to visualize from the outside the path taken by the tracks inside the ramp or tailgate when the tailgate is closed.

In order to provide structural strength and yet allow a driver of the vehicle to have better visibility, the ramp or tailgate may be configured from a material that is of a structural integrity required for a tailgate that advantageously is configured to be transparent in one or more or substantially all of the tailgate. The transparency of the tailgate may allow for better visibility during operation of the vehicle.

Chain drive 410a, 410b comprises a pair of chain drives 410a, 410b that extend along ramps 320a,a′ and 320b,b′, respectively. Alternatively, a belt drive or a screw drive may be used. Referring back again to FIG. 3, the carriage 230 may be secured at opposite ends to the chain drive. Mechanisms for securing of a carriage to a chain for driving the carriage in accordance with the action of the chain are well known. Illustratively, one end of an open loop chain may be attached to one end of the carriage with the other end of the open loop chain attached to the other end. In one example, a master link may be attached between the end of the chain and the carriage with one end of the master link connected to the chain and the other end fixedly attached to the carriage. In these and other mechanisms for attaching a carriage to a drive chain well known in the prior art, carriage 230 of this disclosure may be attached to chain 320 for operating the carriage in accordance with this disclosure.

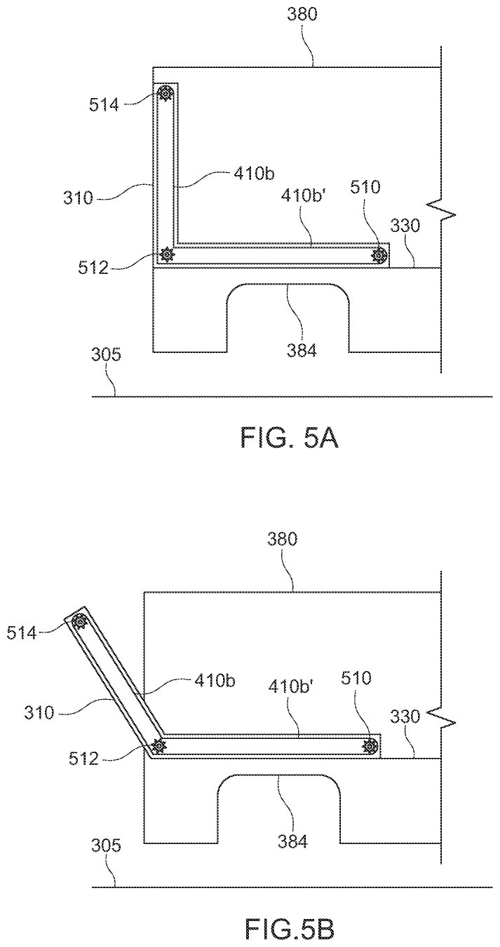

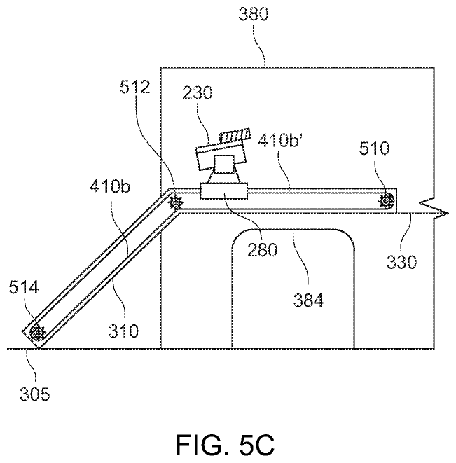

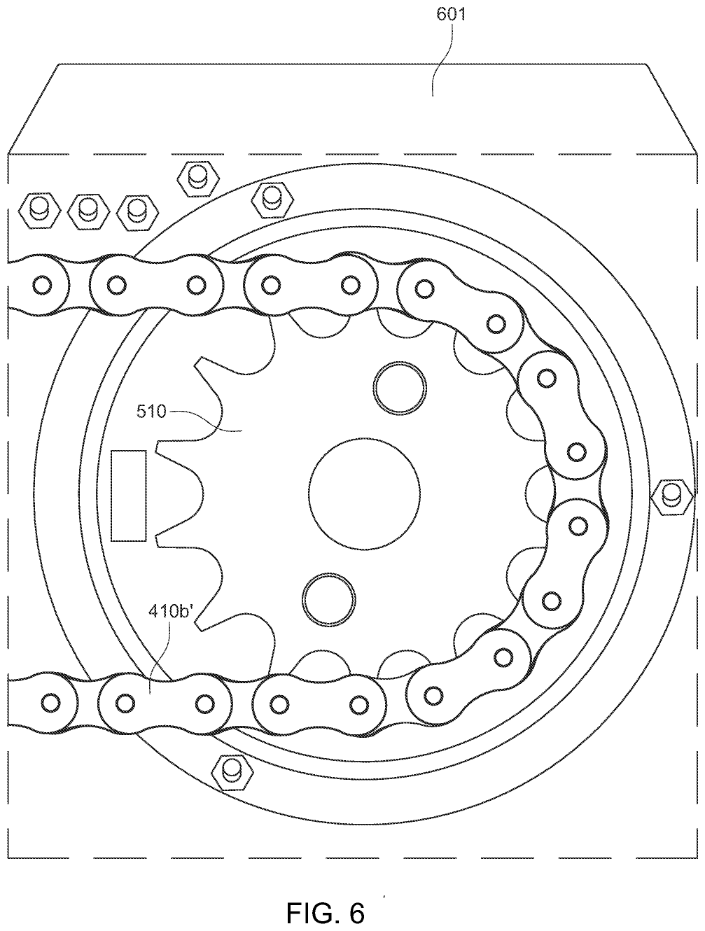

FIGS. 5A, 5B, 5C (collectively FIG. 5) show an illustrative embodiment of positioning an illustrative chain drive embodiment of this disclosure. FIG. 5C depicts the ramp 310 extending down to ground 305. FIG. 5B depicts the ramp 310 to partially close the tail window frame 386 and FIG. 5A depicts the ramp completely closing the tail window frame 386. As shown, the chain drive 410a, 410b of this example uses a pair of chains, one running along ramp 320a,a′ and the other along ramp 320b,b′. Attached to the chain is carriage 280 on which sits the fifth wheel 230 as depicted in FIG. 5C. In particular, one side of carriage 280 is attached to chain drive 410a and the other side of carriage 280 is attached to chain drive 410b; the attachments being as previously described. The controller motor 601 drives both chain drives 410a, b synchronously and in so doing moves carriage 280 and the fifth wheel 230 attached thereto up and down ramps 320a, a′ and 320b, b′. When the king pin 220 of wheel chair 10 (shown in FIG. 2) is coupled to the fifth wheel 230, the chain drives 410a, b move the wheel chair along the ramp 310 from the ground 305 and down the bed 330 of the vehicle 380 depicted in FIGS. 6 and 9, 10 until the wheel chair comes to a stop at ramp stops 73a, 73b depicted in FIG. 10. In so operating, the chain drives operate to position the wheel chair with respect to the vehicle responsive to the action of the controller motor.

The chain drive may be connected to a system of rollers, gears, and pins that may be balanced to position the chain drive wheel chair positioning system smoothly over and over. FIG. 5 depicts sprockets 510, 512, 514 used in this example. Each chain of the pair of chain drives is fitted around a drive sprocket. FIG. 5 depicts chain drive 410b, b′ around drive sprocket 510. Chain drive 410a, a′ is fitted around a similar drive sprocket. Both drive sprockets may be powered by the motorized controller 601 depicted in FIG. 9. Alternatively, a separate motor may be used to power each chain drive. As depicted in FIG. 5, chain drive 410b, b′ loops around an idler sprocket 512 where the bed of the vehicle and the ramp meet. The 410b portion of chain drive 410b, b′ then loops around an idler sprocket 514 at the end of the ramp. The teeth of the sprockets mesh with holes in the links of the chain drive so that mechanical force imparted on the drive sprocket turn the chain and idler sprockets. The movement of the teeth of the sprockets by the turning of the drive sprocket by the power controller 601 causes the mechanical force imparted on the drive sprocket to move the chain drive up and down the tracks of the bed and ramp

The chain drive causes the wheel chair to travel under the influence of the motorized controller along the rectilinear path defined along a bed of a vehicle and a ramp extending therefrom to the ground when the king pin on the wheel chair has been positioned within the opening of the horseshoe of the fifth wheel and locked to the fifth wheel by moving the lock jaw assembly and the extending member of the lock catch back to a locked position.

In an alternative embodiment, a wheelchair for onboarding a wheel chair person into a vehicle may include a wheelchair and a fifth wheel adapted to the wheelchair. The fifth wheel may be configured to receive a king pin adapted to a carriage configured for moving the wheelchair into a vehicle. In other words, and with reference to FIG. 2, the kingpin 220 may be attached to carriage 280 and the fifth wheel 230 to the wheel chair with these two elements coupling together as previously explained and when coupled moving the wheel chair up and down the ramp and bed of the vehicle by the pair of chain drives under the influence of the motorized controller as previously explained.

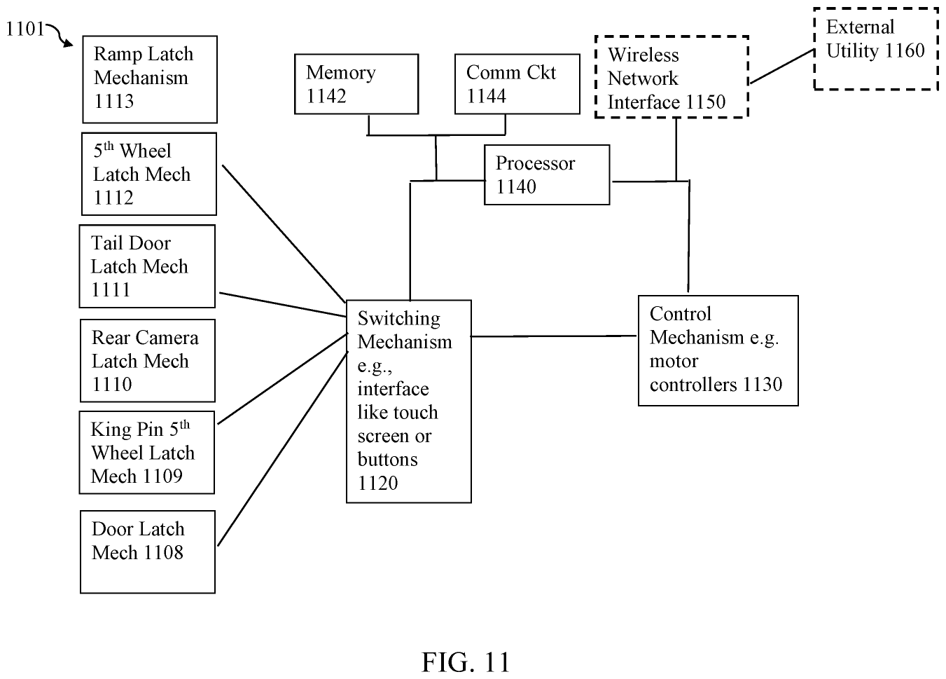

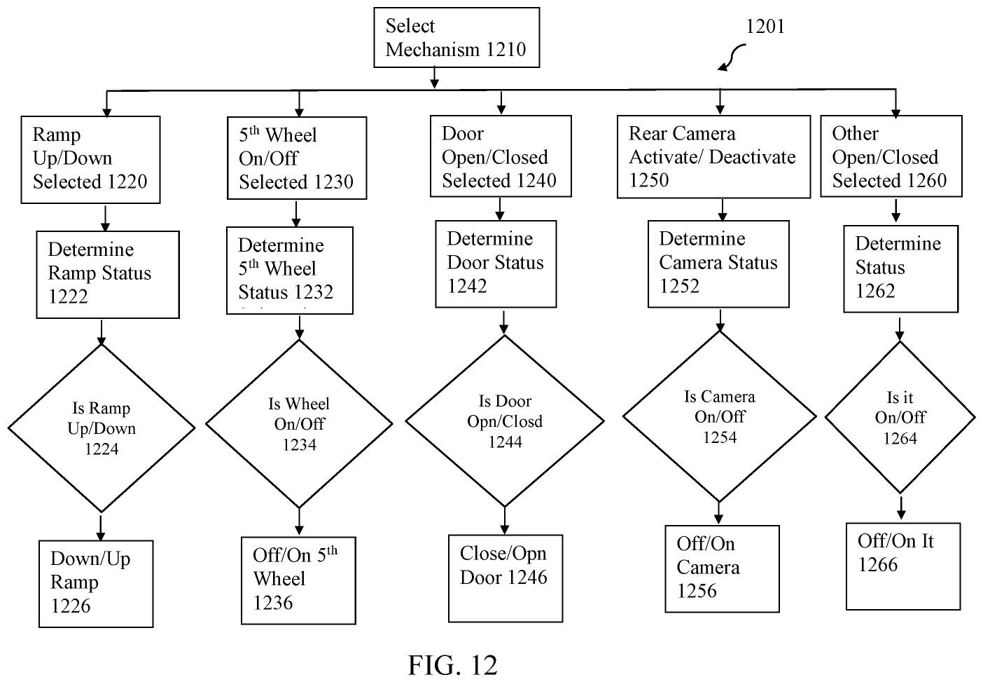

FIG. 9 shows top plan view and FIG. 10 a perspective view of an illustrative embodiment of a system 901 according to this disclosure. In FIG. 10 the ramp 310 or tailgate is depicted open and against the ground. In FIG. 9, person 5 is depicted to illustrate how person 5 would be situated in wheel chair 10 inside vehicle 380. System 901 for onboarding a wheel chair person into a vehicle may include a wheelchair 10, a carriage 280, a fifth wheel 230, a king pin 220, a ramp latch mechanism (1113 in FIG. 11) (e.g., a software latch in the software, but could be a manually or automatically controllable hardware latch associated with the motorized controllers 340a, b to ensure proper safe operation of the ramp), a fifth wheel latch mechanism (1112 in FIG. 12) (e.g., a software latch in the software, but could be a manually or automatically controllable hardware latch associated with the motorized controller 601 to ensure proper safe operation of the motor and hence the chain drives, carriage, and wheel chair) a processor, memory, and a switching mechanism (e.g., a software set of switches in the software, but could be a manually or automatically controllable switches associated with the features controlled by the switching mechanism as herein explained).

System 901 further shows motorized controller 601 and ramp stops 1027a, 1076a (shown in FIG. 10).

System 901 further shows steering wheel 911, driver seat 921, passenger seats 923, 925, computing device 905, dash display 910, and driver panel shield 932, passenger panel shield 934, and wheel chair panel shield 936.

System 901 may further include a door step (not shown) associated with door 927. The door step may be automated and controlled by a motorized assembly. The motorized assembly may include a door opener/close mechanism driven by an electric motor. Alternatively, a conventional door step may be moved. Additional doors on the vehicle 380 if included may also include a door step as previously described.

In the system, the wheelchair 10 may be adapted with either a king pin 220 or a fifth wheel 230. The carriage 280 may be adapted with either the fifth wheel 230 if the wheelchair is adapted with the king pin 220 or the king pin 220 if the wheelchair is adapted with the fifth wheel 230. The carriage 280 may be moveable horizontally under the influence of a motorized controller on a rectilinear path defined along the bed 330 of the vehicle 380 and the ramp 310 extending therefrom to the ground. The fifth wheel may be adapted to the carriage if the king pin is adapted to the wheelchair or to the wheelchair if the king pin is adapted to the carriage. The king pin may be adapted to the wheelchair if the king pin is adapted to the carriage or to the carriage if the king pin is adapted to the wheelchair, the kingpin configurable to be positionable within the opening of the horseshow of the fifth wheel. The carriage may move the wheel chair under the influence of the motorized controller horizontally along the rectilinear path defined along a bed of a vehicle and a ramp extending therefrom to the ground when the king pin has been positioned within the opening of the horseshoe of the fifth wheel and locked to the fifth wheel by moving the lock jaw assembly and the extending member of the lock catch back to a locked position.

System 901 may further include a control system 1101 as depicted in FIG. 11. The control system may include a processor 1140, memory, 1142, communication circuit 1144, a control mechanism 1130, a switching mechanism 1120, and latch mechanisms like ramp latch mechanism 1113, fifth wheel latch mechanism 1112, tail door latch mechanism 1111, rear camera latch mechanism 1110, king pin to fifth wheel latch mechanism 1109, door latch mechanism 1108, and other latch mechanisms to ensure the operation of the features contemplated by this disclosure. The ramp latch mechanism 1113 may be configured for latching and unlatching the operation of the ramp as depicted in FIG. 12. The fifth wheel latch mechanism may be configured for latching and unlatching the operation of the fifth wheel as depicted in FIG. 12. The memory may be in electronic communication with the processor and include instructions executed by the processor to perform the steps depicted in FIG. 12.

The system may further include a rear camera and the rear camera latch mechanism (1110 in FIG. 11) (e.g., a software latch in the software, but could be a manually or automatically controllable hardware latch associated with motorized controller 601 or another motorized controller to ensure proper safe operation of the camera) which may be configured for activating and deactivating the operation of the rear camera. The instructions in memory being further executable by the processor to: select camera latch mechanism, determine camera status, and activate/deactivate the rear camera as depicted in FIG. 12.

The system may include features like loudspeaker and microphone separately operable from or also controllable by the system in accordance with this disclosure. For instance, an intercom microphone/loudspeaker may be provided along the tail window frame 386 of the vehicle 380. It may be integrally controlled by the system to allow for controlled communication between a driver and a person in or about a wheelchair. Alternatively, the intercom may be a stand-alone device that allows two way communication between operator and a person in or about a wheelchair. Advantageously, a loudspeaker and/or microphone integrated into the system allows system control of communications over the loudspeaker and/or microphone which allows for documenting, archiving, etc. purposes as disclosed below.

The system may further include a king pin to fifth wheel latch mechanism 1109 which may be configured for latching and unlatching the operation of the king pin and fifth to each other. (1109 in FIG. 11) (e.g., a software latch in the software, but could be a manually or automatically controllable hardware latch associated with motorized controller 601 or another motorized controller to ensure proper safe operation of the king pin to fifth wheel engagement and disengagement) which may be configured for latching and unlatching the operation of the king pin and fifth wheel.) As depicted in FIG. 12, the instructions in memory being further executable by the processor to: select king pin and fifth wheel latch mechanism, determine status, and open/close the fifth wheel.

The system may further include a door latch mechanism which may be configured for latching and unlatching the operation of the door. (1108 in FIG. 11) (e.g., a software latch in the software, but could be a manually or automatically controllable hardware latch associated with motorized controller 601 or another motorized controller to ensure proper safe operation of the door) which may be configured for latching and unlatching the operation of the door.) As depicted in FIG. 12, the instructions in memory being further executable by the processor to: select door latch mechanism, determine door status, and open/close the door. If the door is associated with an automated door step, the door latch mechanism may also the automated door step.

The system may further include a 5^{th} wheel latch mechanism, alternatively called wheel chair latch mechanism 1112 which may be configured for latching and unlatching the operation of wheel chair latch mechanisms 1072a,a′,b,b′ (see FIG. 10) (e.g., a software latch in the software, but could be a manually or automatically controllable hardware latch associated with motorized controller 601 or another motorized controller to ensure proper safe immobilization of the wheel chair during movement) which may be configured for latching and unlatching the operation of the wheel chair latch.) As depicted in FIG. 12, the instructions in memory being further executable by the processor to: select latch mechanism 1260, determine status 1262, and off/on it. In an illustrative embodiment, when activated, each latch pair may extend in front of and behind the nearby wheel to provide blocks to keep the wheel chair from moving when the vehicle is in motion. Alternatively, when activated, each latch pair may extend in front of and behind one or a pair of spokes of the wheel chair to block the wheel chair from moving when the vehicle is in motion. In another embodiment, a part of a frame of the wheel chair may be provided with an opening for receiving the extended latches when activated to keep the wheel chair from moving while the vehicle is in motion. One or more combinations of the foregoing may also be used.

The system may further include a tail door latch mechanism which may be configured for latching and unlatching the operation of the tail door. (1111 in FIG. 11) (e.g., a software latch in the software, but could be a manually or automatically controllable hardware latch associated with motorized controller 601 or another motorized controller to ensure proper safe operation of the tail door) which may be configured for latching and unlatching the operation of the tail door.) As depicted in FIG. 12, the instructions in memory being further executable by the processor to: select tail door latch mechanism, determine tail door status, and open/close the tail door.

Referring to FIG. 12, the switching mechanism 1120 may be configured to activate/deactivate different features of the system. The instructions may be stored in the memory. The instructions may be executable by the processor to: select ramp latch mechanism, determine ramp status, and active up/down the ramp; select fifth wheel latch mechanism, determine fifth wheel status, and on/off the fifth wheel. The system may activate up/down the ramp of the select ramp latch mechanism, determine ramp status, and active up/down the ramp instruction activates the motorized controller to move the carriage.

The processor may be hardware and software configured to process instructions. The processor may be implemented in any number of ways. Such ways include, by way of example and not of limitation, digital and/or analog processors such as microprocessors and digital-signal processors (DSPs); controllers such as microcontrollers; software running in a machine; programmable circuits such as Field Programmable Gate Arrays (FPGAs), Field-Programmable Analog Arrays (FPAAs), Programmable Logic Devices (PLDs), Application Specific Integrated Circuits (ASICs), any combination of one or more of these, and so on.

Memory may be any physical device capable of storing information temporarily or permanently. Memory may be implemented in any number of ways. Such ways include, by way of example and not of limitation, nonvolatile memories (NVM), read-only memories (ROM), random access memories (RAM), any combination of these, etc. Memory 420 may include programs containing instructions for execution by processor 420. The programs provide instructions for execution by the processor 420, and can also include instructions regarding protocols and decision making analytics, etc. that can be used by sensors 440 as explained below. In addition, memory 420 can store rules, configurations, data, etc.

The switching mechanism 1120 may be configured on dash display 910 via a touch screen. Alternatively, the switching mechanism may be configured to include manually activatable buttons or a combination of digital and manually activatable objects.

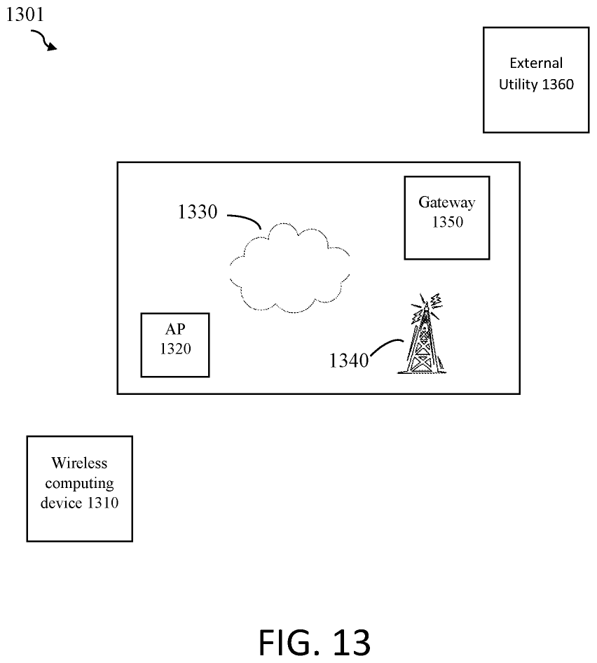

FIGS. 11 and 13 shows connection of the system with an external utility 1160, 1360, respectively, according to this disclosure. The wireless computing device 1310 may be computing device 905 alone or in combination with other computing devices as herein disclosed. Illustratively, the wireless computing device 1310 comprises communication circuitry comprising transceiver circuitry and software for sending and receiving packets over a wireless network (e.g., an IEEE 802.11 WLAN). Alternatively, the transceiver may be hardware and software configured to transmit data to and from the electronic control system via communication circuit 1144 and a network or an external device including Wi-Fi, blue tooth CDMA, and so on, that enables a wireless communication link for between the electronic control system and an external device. The wireless communication may be through the cloud 1330 or cellular base station 1340 and the wireless network interface 1150 may allow an operator to govern those communications.

In an alternative embodiment, the wireless network interface 1150 may be provided by another computing device like a smart phone. The connection between the computing device 905 and the smart phone may be wireless such as through blue tooth. Alternatively, the wireless connection may be combined with or replaced by a hardwire connect for electrically connecting the electronic control system controlled by computing device 905 to the network by wire, such as one or more ports and associated circuitry and software that allow wired communication between the electronic control system and an external device through e.g., an Ethernet connector, an RS232 connector, a USB or other wire connector.

A wireless or hardwire connect may be used, for example, to wireless connect or tether a smart phone to computing device 905 of the electronic control system to enable the functionality of the smart phone to assist, augment, enhance, or complement functionality that is provided by the system. In a wireless example, a blue tooth circuit in communication circuit 1144 may wirelessly connect to a smart phone which may communicate with external devices or a network via cellular or wifi connection. The touch display of a smart phone may provide the dash display 910 of the computing device 905 in this example. In another example, a tether between the communication circuit 1144 and a smart phone may permit the wireless network interface of the smart phone to serve as wireless network interface 1150 to be used by the electronic control system to communicate with external devices or a network. For example, a smart phone received and held in a pocket of a garment worn by the operator may be tethered to the electronic control system so as to allow the smart phone to communicate with the electronic control system to perform the functionalities of this disclosure. For example, the touch-screen of the display may provide the touch sensitive screen of, for example, the electronic control system controlled by computing device 905. In another example, the wireless network interface of the smart phone may provide computing device 905 with the wireless communication link with a network. In another example, computing device 905 may be a smart phone.

In another embodiment, the hardwire connect of a smart phone to the system may be in the form factor of a docking station for receiving and holding the smart phone firmly to the system and electrically connecting the smart phone to system. The docking station may be provided with an electrical connector for mating with the charge port of a smart phone to provide an electrical connection between the two. The docking station may provide a simplified way of plugging in the smart phone to the system of this disclosure. The wireless network interface 1050, hardwire connect, or both may enable any computing device to be electrically connected to the system of this disclosure to provide control instructions to the system. Thus, for example, the smart phone may serve as the computing device 905 in this example.

Broadly speaking, by computing device is meant servers, intermediary servers, personal computers, cellular phones, smart phones, wireless computers, wireless lap-top computers, mobile devices such as tablet computers, pad computers, personal digital assistant, wireless sensors or networks of sensors, such as mesh network sensors, and so on may be in electrical communication with to provide functionality to the electronic control system.

The external utility 1360 may be a server used to store data captured by the camera, loudspeaker, microphone, and so on for investigative, historical, archival, or other purposes. The vehicle may be connected to the server through an application running on the electronic control system of the system. The connection may be bi-directional and include connections between the vehicle and persons at the external utility or at some other remote location that may also be connected to the external utility and who may be online to provide coaching to the operator of the vehicle. For instance, a medical doctor may coach the operator of the vehicle or others nearby on how to perform CPR on a person that has come to be associated with the vehicle, such as a person in a wheelchair or a passenger in the vehicle or even the driver. The external service may provide updated software and/or provide control instructions to control one or more features of the system. For instance, the external server may send the control signals that lower the ramp, couple the king pin to the fifth wheel, and so on. In this embodiment, some or substantial or all of the control of the functionality of the system according to this disclosure may be controlled remotely by a utility service.

In another illustrative embodiment, a wireless mobile device such as a smartphone or other computing device may provide the control system of this disclosure. For example, a smartphone may replace the processor of the computing device 905 in, for example, FIG. 9. In this embodiment, the smartphone may provide the processor, memory, and wireless network interface functionalities of the electronic control system according to this disclosure.

Referring back to FIGS. 9, 10 system 901, driver seat 921 and passenger seats 923, 925 may be conventional seats. Alternatively, any one or more of the seats may also be controlled by the controllers explained in this disclosure.

Driver panel shield 932, passenger panel shield 934, and wheel chair panel shield 936 may be a panel sufficiently rigid enough to stand upright when attached to the vehicle 380 and including an area that is sufficiently large enough to prevent the transmission of air born germs, viruses (like Covid), and so on from one person to another on the vehicle. Illustratively the panel may be made from plexiglass and be transparent so as to allow persons on the vehicle to see each other. The form factor and materials for use as the panel is a matter of design chosen to accomplish the objectives of the system set forth in this disclosure.

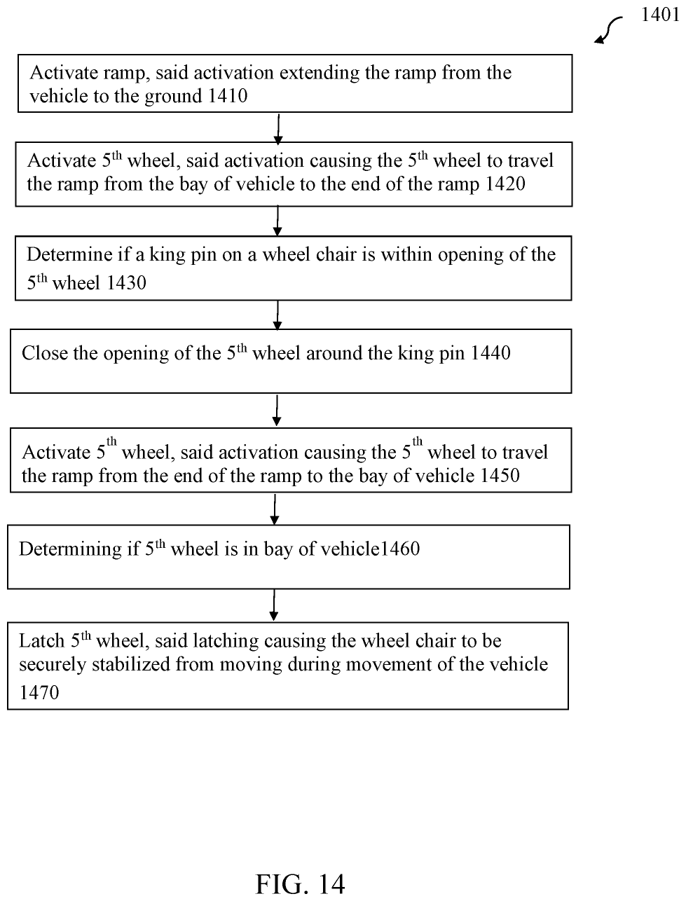

FIG. 14 shows a method of this disclosure. Illustrative method for onboarding a wheel chair person into a vehicle may include the steps of: activate ramp 1410, said activation extending the ramp from the vehicle to the ground; activate fifth wheel 1420, said activation causing the fifth wheel to travel the ramp from the bay of vehicle to the end of the ramp; determine 1430 if a king pin on a wheel chair is within opening of the fifth wheel; close 1440 the opening of the 5th wheel around the king pin; activate 1450 the fifth wheel, said activation causing the fifth wheel to travel the ramp from the end of the ramp to the bay of vehicle; determine 1460 if the fifth wheel is in bay of vehicle; latch 1460 the fifth wheel, said latching causing the wheel chair to be securely stabilized from moving during movement of the vehicle.

Referring back to FIG. 9, in operation, a driver sits in driver seat 921, on dash display 910 sees through camera 962 the ramp 310 and its position with respect to the ground, the wheel chair on the ramp, the king pin to fifth wheel engagement, the movement of the wheel chair along the ramp and the locking of latches 72a-78a when the wheelchair is in position. The panels 932, 934, 936 protect driver, passengers, and wheelchair user against Covid or other transmissions. Through the control system herein disclosed, the functionalities herein described may be automated and monitored by the driver and/or be a remote utility.

In an illustrative method according to this disclosure, onboarding a wheel chair person into a vehicle may include the steps of: activate ramp, said activation extending the ramp from the vehicle to the ground; activate fifth wheel, said activation causing the fifth wheel to travel the ramp from the bay of vehicle to the end of the ramp; determine if a king pin on a wheel chair is within opening of the fifth wheel; close the opening of the 5th wheel around the king pin; activate the fifth wheel, said activation causing the fifth wheel to travel the ramp from the end of the ramp to the bay of vehicle; determine if the fifth wheel is in bay of vehicle; latch the fifth wheel, said latching causing the wheel chair to be securely stabilized from moving during movement of the vehicle.

While the disclosure has been described in conjunction with specific embodiments, it is evident that numerous alternatives, modifications, and variations will be apparent to those skilled in the art within the spirit and scope of the disclosure described above.

There is thus disclosed a wheelchair for onboarding a wheel chair person into a vehicle including a wheelchair and a king pin adapted to the wheelchair. The kingpin may be configured to be positionable within an opening of a fifth wheel adapted to a vehicle configured for moving the wheelchair into a vehicle.

The wheelchair may be used in combination with a fifth wheel.

The fifth wheel may include a flat plate, a lock jaw assembly, a lock catch, a lock bar, a lock bar spring, and a handle catch. The flat plate may be formed in the shape of a horseshoe defining an opening. The lock jaw assembly may define along an inner region an opening in the shape of the horseshoe opening and along an outer region a set of teeth. The lock catch may pivotally attach to the fifth wheel. The lock catch may define an extending member configured to engage the set of teeth of the lock jaw assembly. The lock bar may extend along a top of the horseshoe opening of the flat plate and include a set of teeth for mating with the set of teeth of the lock jaw assembly. The lock bar may be configured for axial movement along the top of the horseshoe opening. The lock bar spring may be secured at one end to the flat plate and at an other end to a handle catch. The lock bar may be configured for axial movement along the top of the lock bar. The handle catch may be configured for axial movement along the top of the lock bar spring. Extension of the handle catch away from the flat plat may move the lock bar in a direction away from the flat plate under the influence of the spring with the set of teeth of the lock bar rotably moving the lock jaw assembly and the extending member of the lock catch to an unlocked position. Relaxation of the handle may return the lock bar and the spring to a normal position with the set of teeth of the lock bar rotably moving the lock jaw assembly and the extending member of the lock catch back to a locked position.

The wheelchair and fifth wheel combination may further include a carriage moveable horizontally under the influence of a motorized controller on a rectilinear path defined along a bed of a vehicle and a ramp extending therefrom to the ground. The fifth wheel may be adapted to the carriage.

The ramp extending from the vehicle to the ground may be configured to provide a tailgate for the vehicle. The ramp extending from the vehicle to the ground may be configured to provide a hatch for the vehicle.

The ramp extending from the vehicle to the ground may be configured to lie on or under the bed of the vehicle.

The carriage may move the wheel chair under the influence of the motorized controller horizontally along the rectilinear path defined along a bed of a vehicle and a ramp extending therefrom to the ground when the king pin has been positioned within the opening of the horseshoe of the fifth wheel and locked to the fifth wheel by moving the lock jaw assembly and the extending member of the lock catch back to a locked position.

The fifth wheel may further include a sensor. The sensor may detect when the king pin has been positioned within the opening of the horseshoe of the fifth wheel. The detected positioning may be a condition for operation of the motorized controller.

The kingpin may be adapted to an underside of the wheelchair.

The underside of the wheelchair may be the underside of a footrest of the wheelchair.

The kingpin may be a part of a wheelchair accessory item and the adaption of the kingpin to the underside of the wheelchair to the underside of a footrest of the wheelchair may be by attachment of the wheelchair accessory item to the footrest of the wheelchair.

In an alternative embodiment, a wheelchair for onboarding a wheel chair person into a vehicle may include a wheelchair and a fifth wheel adapted to the wheelchair. The fifth wheel may be configured to receive a king pin adapted to a vehicle configured for moving the wheelchair into a vehicle.

The wheelchair may be in combination with a king pin.

The fifth wheel may include a flat plat, a lock jaw assembly, a lock catch, a lock bar, a lock bar spring, and a handle catch. The flat plate may be formed in the shape of a horseshoe defining an opening. The lock jaw assembly may define along an inner region an opening in the shape of the horseshoe opening and along an outer region a set of teeth. The lock catch may pivotally attach to the fifth wheel. The lock catch may define an extending member configured to engage the set of teeth of the lock jaw assembly. The lock bar may extend along a top of the horseshoe opening of the flat plate and include a set of teeth for mating with the set of teeth of the lock jaw assembly. The lock bar may be configured for axial movement along the top of the horseshoe opening. The lock bar spring may be secured at one end to the flat plate and at an other end to a handle catch. The lock bar may be configured for axial movement along the top of the lock bar. The handle catch may be configured for axial movement along the top of the lock bar spring. Extension of the handle catch away from the flat plat may move the lock bar in a direction away from the flat plate under the influence of the spring with the set of teeth of the lock bar rotably moving the lock jaw assembly and the extending member of the lock catch to an unlocked position. Relaxation of the handle may return the lock bar and the spring to a normal position with the set of teeth of the lock bar rotably moving the lock jaw assembly and the extending member of the lock catch back to a locked position.

The wheelchair may further include a carriage moveable horizontally under the influence of a motorized controller on a rectilinear path defined along a bed of a vehicle and a ramp extending therefrom to the ground. The kingpin may be adapted to the carriage.

The ramp extending from the vehicle to the ground may be configured to provide a tailgate for the vehicle. The ramp extending from the vehicle to the ground may be configured to provide a hatch for the vehicle.

The ramp extending from the vehicle to the ground may be configured to lie on or under the bed of the vehicle.

The carriage may move the wheel chair under the influence of the motorized controller horizontally along the rectilinear path defined along a bed of a vehicle and a ramp extending therefrom to the ground when the king pin has been positioned within the opening of the horseshoe of the fifth wheel and locked to the fifth wheel by moving the lock jaw assembly and the extending member of the lock catch back to a locked position.

The fifth wheel may further include a sensor. The sensor may detect when the king pin has been positioned within the opening of the horseshoe of the fifth wheel. The detected positioning being a condition for operation of the motorized controller.

The fifth wheel may further a sensor, electrical circuitry, and communication circuitry. The sensor may generate an electrical signal when the king pin has been positioned within the opening of the horseshoe of the fifth wheel. The electrical circuitry may apply a signal to the communication circuitry on detection of the sensor generated electrical signal. The communication circuitry may be configured to transmit a signal to a receiver in response to the signal applied by the electrical circuitry. The detected positioning may be a condition for operation of the motorized controller.

The fifth wheel may be adapted to an underside of the wheelchair.

The underside of the wheelchair may be the underside of a footrest of the wheelchair.

The fifth wheel may be a part of a wheelchair accessory item and the adaption of the fifth wheel to the underside of the wheelchair to the underside of a footrest of the wheelchair may be by attachment of the wheelchair accessory item to the footrest of the wheelchair.

In another embodiment, a system for onboarding a wheel chair person into a vehicle may include a wheelchair, a carriage, a fifth wheel, a king pin, a ramp latch mechanism, a fifth wheel latch mechanism, a processor, memory, and a switching mechanism. The wheelchair may be adapted with either a king pin or a fifth wheel. The carriage may be moveable horizontally under the influence of a motorized controller on a rectilinear path defined along a bed of a vehicle and a ramp extending therefrom to the ground. The fifth wheel may be adapted to the carriage if the king pin is adapted to the wheelchair or to the wheelchair if the king pin is adapted to the carriage. The king pin may be adapted to the wheelchair if the king pin is adapted to the carriage or to the carriage if the king pin is adapted to the wheelchair, the kingpin configurable to be positionable within the opening of the horseshow of the fifth wheel. The carriage may move the wheel chair under the influence of the motorized controller horizontally along the rectilinear path defined along a bed of a vehicle and a ramp extending therefrom to the ground when the king pin has been positioned within the opening of the horseshoe of the fifth wheel and locked to the fifth wheel by moving the lock jaw assembly and the extending member of the lock catch back to a locked position. The ramp latch mechanism may be configured for latching and unlatching the operation of the ramp. The fifth wheel latch mechanism may be configured for latching and unlatching the operation of the fifth wheel. The memory may be in electronic communication with the processor. The switching mechanism may be configured to activate/deactivate different features of the system. The instructions may be stored in the memory. The instructions may be executable by the processor to: select ramp latch mechanism, determine ramp status, and active up/down the ramp; select fifth wheel latch mechanism, determine fifth wheel status, and on/off the fifth wheel;

The fifth wheel may include a flat plate, a lock jaw assembly, a lock catch, a lock bar, a lock bar spring, and a handle catch. The flat plate may be formed in the shape of a horseshoe defining an opening. The lock jaw assembly may define along an inner region an opening in the shape of the horseshoe opening and along an outer region a set of teeth. The lock catch may pivotally attach to the fifth wheel. The lock catch may define an extending member configured to engage the set of teeth of the lock jaw assembly. The lock bar may extend along a top of the horseshoe opening of the flat plate and include a set of teeth for mating with the set of teeth of the lock jaw assembly. The lock bar may be configured for axial movement along the top of the horseshoe opening. The lock bar spring may be secured at one end to the flat plate and at an other end to a handle catch. The lock bar may be configured for axial movement along the top of the lock bar. The handle catch may be configured for axial movement along the top of the lock bar spring. Extension of the handle catch away from the flat plat may move the lock bar in a direction away from the flat plate under the influence of the spring with the set of teeth of the lock bar rotably moving the lock jaw assembly and the extending member of the lock catch to an unlocked position. Relaxation of the handle may return the lock bar and the spring to a normal position.

The system may further include a rear camera latch mechanism which may be configured for latching and unlatching the operation of the rear camera. The instructions in memory being further executable by the processor to: select camera latch mechanism, determine camera status, and activate/deactivate the rear camera.

The system may further include a microphone and speaker.

The system may further include a door latch mechanism which may be configured for latching and unlatching the operation of the door. The instructions in memory being further executable by the processor to: select door latch mechanism, determine door status, and open/close the door.

The system may activate up/down the ramp of the select ramp latch mechanism, determine ramp status, and active up/down the ramp instruction activates the motorized controller to move the carriage.

The switching mechanism of the system may be a touch screen.

The processor, memory in electronic communication with the processor; the switching mechanism; and instructions stored in the memory may be provided by a computing device.

The computing device is a smart phone.

The system may further include a microphone and a loudspeaker.

The fifth wheel adapted to the carriage may further comprising a sensor, the sensor detecting when the king pin has been positioned within the opening of the horseshoe of the fifth wheel.

The system may further include panels configured for creating a no contact barrier between persons in the vehicle.

The fifth wheel may further include a sensor, electrical circuitry, and communication circuitry. The sensor may generate an electrical signal when the king pin has been positioned within the opening of the horseshoe of the fifth wheel. The electrical circuitry may apply a signal to the communication circuitry on detection of the sensor generated electrical signal. The communication circuitry may be configured to transmit a signal to a receiver in response to the signal applied by the electrical circuitry. The detected positioning being a condition for operation of the motorized controller.

The system may further include a wireless network interface. The wireless network interface may be configured to communicate data to a remote location.

The remote location may be an external utility. The external utility may be configured to communicate with the wireless network interface.

An illustrative method for onboarding a wheel chair person into a vehicle may include the steps of: activate ramp, said activation extending the ramp from the vehicle to the ground; activate fifth wheel, said activation causing the fifth wheel to travel the ramp from the bay of vehicle to the end of the ramp; determine if a king pin on a wheel chair is within opening of the fifth wheel; close the opening of the 5th wheel around the king pin; activate the fifth wheel, said activation causing the fifth wheel to travel the ramp from the end of the ramp to the bay of vehicle; determine if the fifth wheel is in bay of vehicle; latch the fifth wheel, said latching causing the wheel chair to be securely stabilized from moving during movement of the vehicle.

1. A wheelchair for onboarding a wheel chair person into a vehicle comprising:
a wheelchair;
a king pin adapted to a footrest of the wheelchair, the kingpin configured to be positionable within an opening of a fifth wheel adapted to a carriage of a vehicle configured for moving the wheelchair along a ramp into a bed of a vehicle.

2. The wheelchair of claim 1 in combination with a fifth wheel adapted to a carriage of a vehicle.

3. The wheelchair of claim 2 wherein the fifth wheel comprising.
a housing formed in the shape of a horseshoe defining an opening,
a lock jaw assembly, the lock jaw assembly defining along an inner region an opening in the shape of the horseshoe opening and along an outer region a set of teeth.
a lock catch pivotally attached to the fifth wheel, the lock catch defining an extending member configured to engage the set of teeth of the lock jaw assembly,
a lock bar extending along a top of the horseshoe opening of the housing, the lock bar including a set of teeth for mating with the set of teeth of the lock jaw assembly, the lock bar configured for axial movement along the top of the horseshoe opening,
a lock bar spring secured at one end to the housing and at an other end to a handle catch, the lock bar configured for axial movement along the top of the lock bar, and
the handle catch configured for axial movement along the top of the lock bar spring,
wherein extension of the handle catch away from a flat plat moves the lock bar in a direction away from the housing under the influence of the spring with the set of teeth of the lock bar rotatably moving the lock jaw assembly and the extending member of the lock catch to an unlocked position, and
wherein relaxation of the handle returns the lock bar and the spring to a normal position with the set of teeth of the lock bar rotatably moving the lock jaw assembly and the extending member of the lock catch back to a locked position

4. The wheelchair of claim 2 further comprising:
a carriage moveable horizontally under the influence of a motorized controller on a rectilinear path defined along a bed of a vehicle and a ramp extending therefrom to the ground;
wherein the fifth wheel is adapted to the carriage.

5. The wheelchair of claim 4 wherein the ramp extending from the vehicle to the ground is configured to provide a tailgate for the vehicle.

6. The wheelchair of claim 4:
wherein the fifth wheel comprising a housing formed in the shape of a horseshoe defining an opening;
wherein the fifth wheel further comprising a sensor, the sensor detecting when the king pin has been positioned within the opening of the horseshoe of the fifth wheel, the detected positioning being a condition for operation of the motorized controller.

7. The wheelchair of claim 1 wherein the kingpin is adapted to an underside of the footrest.

8. The wheelchair of claim 7 wherein the kingpin is a part of a wheelchair accessory item and the adaption of the kingpin to the underside of the wheelchair is to the underside of a footrest of the wheelchair and is by attachment of the wheelchair accessory item to the footrest of the wheelchair.

9. A wheelchair for onboarding a wheel chair person into a vehicle comprising:
a wheelchair;
a fifth wheel adapted to a footrest of the wheelchair, the fifth wheel configured to receive a king pin adapted to a carriage of a vehicle configured for moving the wheelchair along a ramp into a bed of a vehicle.

10. The wheelchair of claim 9 in combination with a king pin adapted to a carriage of a vehicle.

11. The wheelchair of claim 10 wherein the fifth wheel comprising.
a housing formed in the shape of a horseshoe defining an opening,
a lock jaw assembly, the lock jaw assembly defining along an inner region an opening in the shape of the horseshoe opening and along an outer region a set of teeth.
a lock catch pivotally attached to the fifth wheel, the lock catch defining an extending member configured to engage the set of teeth of the lock jaw assembly,
a lock bar extending along a top of the horseshoe opening of the housing, the lock bar including a set of teeth for mating with the set of teeth of the lock jaw assembly, the lock bar configured for axial movement along the top of the horseshoe opening,
a lock bar spring secured at one end to the housing and at an other end to a handle catch, the lock bar configured for axial movement along the top of the lock bar, and
the handle catch configured for axial movement along the top of the lock bar spring,
wherein extension of the handle catch away from a flat plat moves the lock bar in a direction away from the housing under the influence of the spring with the set of teeth of the lock bar rotatably moving the lock jaw assembly and the extending member of the lock catch to an unlocked position, and
wherein relaxation of the handle returns the lock bar and the spring to a normal position with the set of teeth of the lock bar rotatably moving the lock jaw assembly and the extending member of the lock catch back to a locked position.

12. The wheelchair of claim 11 further comprising:
a carriage moveable horizontally under the influence of a motorized controller on a rectilinear path defined along a bed of a vehicle and a ramp extending therefrom to the ground; wherein the kingpin is adapted to the carriage.

13. The wheelchair of claim 12 wherein the carriage moving the wheel chair under the influence of the motorized controller horizontally along the rectilinear path defined along a bed of a vehicle and a ramp extending therefrom to the ground when the king pin has been positioned within the opening of the horseshoe of the fifth wheel and locked to the fifth wheel by moving the lock jaw assembly and the extending member of the lock catch back to a locked position.

14. The wheelchair of claim 13 wherein the fifth wheel further comprising a sensor, the sensor detecting when the king pin has been positioned within the opening of the horseshoe of the fifth wheel, the detected positioning being a condition for operation of the motorized controller.

15. The wheelchair of claim 12 wherein the fifth wheel further comprising a sensor, electrical circuitry, and communication circuitry, the sensor generating an electrical signal when the king pin has been positioned within the opening of the horseshoe of the fifth wheel, the electrical circuitry applying a signal to the communication circuitry on detection of the sensor generated electrical signal, the communication circuitry configured to transmit a signal to a receiver in response to the signal applied by the electrical circuitry, the detected positioning being a condition for operation of the motorized controller.

16. A system for onboarding a wheel chair person into a vehicle comprising:
a wheelchair adapted with either a king pin or a fifth wheel;
a carriage moveable horizontally under the influence of a motorized controller on a rectilinear path defined along a bed of a vehicle and a ramp extending therefrom to the ground, the carriage including a fifth wheel if the wheelchair is adapted with a king pin or a king pin if the carriage is adapted with a fifth wheel;
wherein the kingpin configurable to be positionable within an opening of a horseshoe of the fifth wheel;
a ramp latch mechanism configured for changing the operation of the ramp between latched and unlatched states;
a fifth wheel latch mechanism configured for changing the operation of the fifth wheel between latched and unlatched states;
a processor, a memory in electronic communication with the processor; and instructions stored in the memory, the instructions being executable by the processor to:
select the ramp latch mechanism, determine whether the ramp is up or down, and activate the carriage to move along the ramp;
select the fifth wheel latch mechanism, determine whether the king pin is locked or unlocked to the horseshoe of the fifth wheel, and lock or unlock the horseshoe to the fifth wheel.

17. The system of claim 16, the system further comprising:
a rear camera;
a rear camera latch mechanism configured for changing the operation of the rear camera between on and off states;
the instructions in memory being further executable by the processor to:
select the camera latch mechanism, determine whether the camera is on or off, and turn on or off the rear camera.

18. The system of claim 16, the system further comprising:
a door latch mechanism configured for changing the operation of a door between open and closed positions;
the instructions in memory being further executable by the processor to:
select the door latch mechanism, determine whether the door is open or closed, and open or close the door.

19. The system of claim 16, the system further comprising a motorized controller to move the carriage along the ramp.

20. The system of claim 16, the system further comprising panels configured for creating a no contact barrier between persons in the vehicle.

21. The system of claim 16 wherein the system further comprising a wireless network interface, the wireless network interface configured to communicate data to a remote location.

22. The system of claim 21 wherein the remote location is an external utility.

23. A method for onboarding a wheel chair person into a vehicle comprising the steps of:
activating a ramp, said activation extending the ramp from the vehicle to the ground;
activating a carriage including a fifth wheel, said activation causing the carriage with the fifth wheel to travel along the ramp from a bay of the vehicle to the end of the ramp;
determining if a king pin adapted to a footrest of a wheel chair is within an opening of the fifth wheel;
closing the opening of the 5th wheel around the king pin to couple the wheel chair to the carriage;
activating the carriage with the fifth wheel, said activation causing the carriage with the wheel chair to travel the ramp from the end of the ramp to the bay of the vehicle;
determining if the carriage with the wheel chair is in the bay of vehicle;
securing the carriage with the wheel chair to the vehicle.
